(19) United States
(12) Patent Application Publication
(10) Pub. No.: US 2023/0222685 A1
(43) Pub. Date: Jul. 13, 2023

(54) PROCESSING APPARATUS, PROCESSING METHOD, AND NON-TRANSITORY STORAGE MEDIUM

(71) Applicant: NEC Corporation, Minato-ku, Tokyo (JP)

(72) Inventors: Yu Nabeto, Tokyo (JP); Soma Shiraishi, Tokyo (JP); Takami Sato, Tokyo (JP); Katsumi Kikuchi, Tokyo (JP)

(73) Assignee: NEC Corporation, Minato-ku, Tokyo (JP)

(21) Appl. No.: 17/928,970

(22) PCT Filed: Jun. 2, 2020
(86) PCT No.: PCT/JP2020/021841

§ 371 Date: Dec. 1, 2022

(51) Int. Cl. G06T 7/73; G06T 7/62; G06V 10/141; G06V 10/25

(52) U.S. Cl. CPC G06T 7/73; G06T 7/62; G06V 10/141; G06V 10/25; G06V 2201/07; G06T 2207/10152

(57) ABSTRACT

The present invention provides a processing apparatus (10) including an acquisition unit (11) that acquires an image including a product, a detection unit (12) that detects, from the image, a target region being a region including an observation target, a computation unit (13) that computes an evaluation value of an image of the target region, and a registration unit (14) that registers the image as an image for learning, when the evaluation value satisfies a criterion.

### TECHNICAL FIELD

The present invention relates to a processing apparatus, a processing method, and a program.

### BACKGROUND ART

Non-Patent Documents 1 and 2 each disclose a store system in which settlement processing (product registration, payment, and the like) at a cash register counter is eliminated. The technique recognizes, based on an image generated by a camera capturing inside of a store, a product picked up by a customer, and automatically performs settlement processing, based on a recognition result, at a timing when the customer exits the store.

Non-Patent Document 3 discloses a technique of recognizing a product included in an image, by utilizing a deep learning technique and a keypoint matching technique. Moreover, Non-Patent Document 3 discloses a technique of collectively recognizing, by image recognition, a plurality of products of an accounting target mounted on a table.

Patent Document 1 discloses a technique of adjusting illumination light illuminating a product displayed on a product display shelf, based on an analysis result of an image including the product. Patent Document 2 discloses a technique of providing, at an accounting counter, a reading window, and a camera that captures a product across the reading window, capturing the product by the camera when an operator positions the product in front of the reading window, and recognizing the product, based on the image.

### RELATED DOCUMENT

### Patent Document

[Patent Document 1] Japanese Patent Application Publication No. 2008-71662
[Patent Document 2] Japanese Patent Application Publication No. 2018-116371

### Non-Patent Document

[Non-Patent Document 1] Takuya Miyata, “Mechanism of Amazon Go, Supermarket without Cash Register Achieved by ‘Camera and Microphone’”, [online], Dec. 10, 2016,
[Searched on Dec. 6, 2019], the Internet <URL:https://www.huffingtonpost.jp/tak-miyata/amazon-go_b_13521384.html>
[Non-Patent Document 2] “NEC, Cash Register-less Store ‘NEC SMART STORE’ is Open in Head Office—Face Recognition Use, Settlement Simultaneously with Exit of Store”, [online], Feb. 28, 2020, [Searched on Mar. 27, 2020], the Internet <URL: https://japan.cnet.com/article/35150024/>
[Non-Patent Document 3] “Heterogeneous Object Recognition to Identify Retail Products”, [online], [Searched on Apr. 27, 2020], the Internet <URL: https://jpn.nec.com/techrep/journal/g19/n01/190118.html>

### DISCLOSURE OF THE INVENTION

### Technical Problem

As described above, a technique of recognizing a product included in an image is widely considered and utilized. Then, a technique for further improving accuracy of product recognition based on an image is desired. An object of the present invention is to improve accuracy of product recognition based on an image, by a method that is not disclosed by the prior arts described above.

### Solution to Problem

The present invention provides a processing apparatus including:

an acquisition unit that acquires an image including a product;

a detection unit that detects, from the image, a target region being a region including an observation target;

a computation unit that computes an evaluation value of an image of the target region; and

a registration unit that registers the image as an image for learning, when the evaluation value satisfies a criterion.

Moreover, the present invention provides a processing method including,

by a computer:
acquiring an image including a product;
detecting, from the image, a target region being a region including an observation target;
computing an evaluation value of an image of the target region; and
registering the image as an image for learning, when the evaluation value satisfies a criterion.

Moreover, the present invention provides a program causing a computer to function as:

an acquisition unit that acquires an image including a product;

a detection unit that detects, from the image, a target region being a region including an observation target;

a computation unit that computes an evaluation value of an image of the target region; and

a registration unit that registers the image as an image for learning, when the evaluation value satisfies a criterion.

### Advantageous Effects of Invention

The present invention improves accuracy of product recognition based on an image.

### BRIEF DESCRIPTION OF THE DRAWINGS

FIG. 1 is a diagram illustrating one example of a hardware configuration of a processing apparatus according to the present example embodiment.

FIG. 2 is one example of a functional block diagram of the processing apparatus according to the present example embodiment.

FIG. 3 is a diagram for describing a placement example of a camera according to the present example embodiment.

FIG. 4 is a diagram for describing a placement example of the camera according to the present example embodiment.

FIG. 5 is a diagram for describing a placement example of the camera according to the present example embodiment.

FIG. 6 is a flowchart illustrating one example of a flow of processing in the processing apparatus according to the present example embodiment.

FIG. 7 is a diagram for describing a relation between the processing apparatus according to the present example embodiment, a camera, and an illumination.

FIG. 8 is one example of a functional block diagram of the processing apparatus according to the present example embodiment.

FIG. 9 is a diagram for describing one example of an illumination according to the present example embodiment.

FIG. 10 is a flowchart illustrating one example of a flow of processing in the processing apparatus according to the present example embodiment.

### DESCRIPTION OF EMBODIMENTS

### First Example Embodiment

### “Outline”

A processing apparatus according to the present example embodiment includes a function of selecting a candidate image being preferable as an image for learning (a candidate image satisfying a predetermined criterion), from among candidate images (images including a product desired to be recognized) prepared for learning in machine learning or deep learning, and registering the selected candidate image as an image for learning. By performing learning by use of a carefully selected image for learning in this way, accuracy of product recognition of an acquired estimation model improves.

### “Hardware Configuration”

Next, one example of a hardware configuration of the processing apparatus is described. Each functional unit of the processing apparatus is achieved by any combination of hardware and software mainly including a central processing unit (CPU) of any computer, a memory, a program loaded onto the memory, a storage unit such as a hard disk that stores the program (that can store not only a program previously stored from a phase of shipping an apparatus but also a program downloaded from a storage medium such as a compact disc (CD), a server on the Internet, and the like), and an interface for network connection. Then, it is appreciated by a person skilled in the art that there are a variety of modified examples of a method and an apparatus for the achievement.

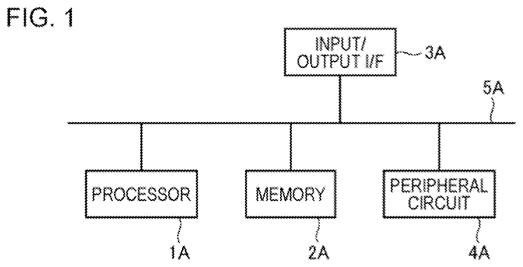

FIG. 1 is a block diagram illustrating a hardware configuration of the processing apparatus. As illustrated in FIG. 1, the processing apparatus includes a processor 1A, a memory 2A, an input/output interface 3A, a peripheral circuit 4A, and a bus 5A. The peripheral circuit 4A includes various modules. The processing apparatus may not include the peripheral circuit 4A. Note that, the processing apparatus may be configured by a plurality of physically and/or logically separated apparatuses, or may be configured by one physically and/or logically integrated apparatus. When the processing apparatus is configured by a plurality of physically and/or logically separated apparatuses, each of the plurality of apparatuses may include the hardware configuration described above.

The bus 5A is a data transmission path for the processor 1A, the memory 2A, the peripheral circuit 4A, and the input/output interface 3A to mutually transmit and receive data. The processor 1A is, for example, an arithmetic processing apparatus such as a CPU and a graphics processing unit (GPU). The memory 2A is, for example, a memory such as a random access memory (RAM) and a read only memory (ROM). The input/output interface 3A includes an interface for acquiring information from an input apparatus, an external apparatus, an external server, an external sensor, a camera, and the like, an interface for outputting information to an output apparatus, an external apparatus, an external server, and the like, and the like. The input apparatus is, for example, a keyboard, a mouse, a microphone, a physical button, a touch panel, and the like. The output apparatus is, for example, a display, a speaker, a printer, a mailer, and the like. The processor 1A can give an instruction to each of modules, and perform an arithmetic operation, based on an arithmetic result of each of the modules.

### “Functional Configuration”

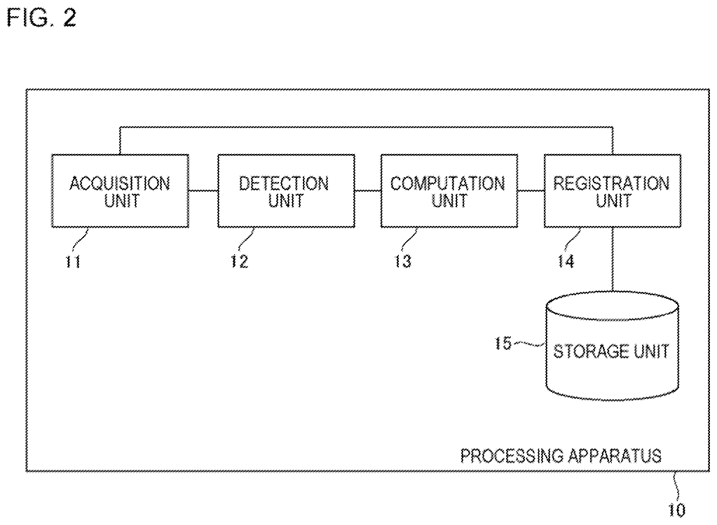

FIG. 2 illustrates one example of a functional block diagram of a processing apparatus 10. As illustrated, the processing apparatus 10 includes an acquisition unit 11, a detection unit 12, a computation unit 13, a registration unit 14, and a storage unit 15.

The acquisition unit 11 acquires an image including a product. “Acquisition” includes at least any one of “fetching, by a local apparatus, data stored in another apparatus or a storage medium (active acquisition)”, based on a user input, or based on an instruction of a program, for example, receiving by requesting or inquiring of the another apparatus, accessing the another apparatus or the storage medium and reading, and the like, “inputting, into a local apparatus, data output from another apparatus (passive acquisition)”, based on a user input, or based on an instruction of a program, for example, receiving data distributed (or transmitted, push-notified, or the like), and selecting and acquiring from received data or information, and “generating new data by editing of data (conversion into text, rearrangement of data, extraction of partial data, alteration of a file format, or the like) or the like, and acquiring the new data”.

An image acquired by the acquisition unit 11 serves as “a candidate image prepared for learning in machine learning or deep learning”. Hereinafter, an image acquired by the acquisition unit 11 is referred to as a “candidate image”.

A candidate image may include a product desired to be recognized. For example, an image prepared by a manufacturer of a product may be utilized as a candidate image, an image published on a network may be utilized as a candidate image, or another image may be utilized as a candidate image. However, in order to improve recognition accuracy, it is preferable that an image generated by capturing a product under a situation similar to an actual utilization scene is determined as a candidate image.

For example, when product recognition based on an estimation model generated by machine learning or deep learning is performed in store business, as disclosed in Non-Patent Documents 1 to 3 and Patent Document 2, it is preferable to capture a product under a situation similar to the utilization scene, and generate a candidate image. One example of a situation in an actual utilization scene is described below.

In a utilization scene of each of Non-Patent Documents 1 and 2, a product picked up by a customer needs to be recognized. Accordingly, one or a plurality of cameras are placed in a store in a position and a direction where the product picked up by the customer can be captured. For example, a camera may be placed, for each product display shelf, in a position and a direction where a product taken out from each of the product display shelves is captured. A camera may be placed on a product display shelf, may be placed on a ceiling, may be placed on a floor, may be placed on a wall surface, or may be placed on another place. Note that, an example in which a camera is placed for each product display shelf is merely one example, and the present invention is not limited thereto.

A camera may capture a moving image constantly (e.g., within an opening hour), may continuously capture a still image at a time interval larger than a frame interval of a moving image, or may execute the captures only while a person being present at a predetermined position (a position in front of a product display shelf or the like) is detected by a human sensor or the like.

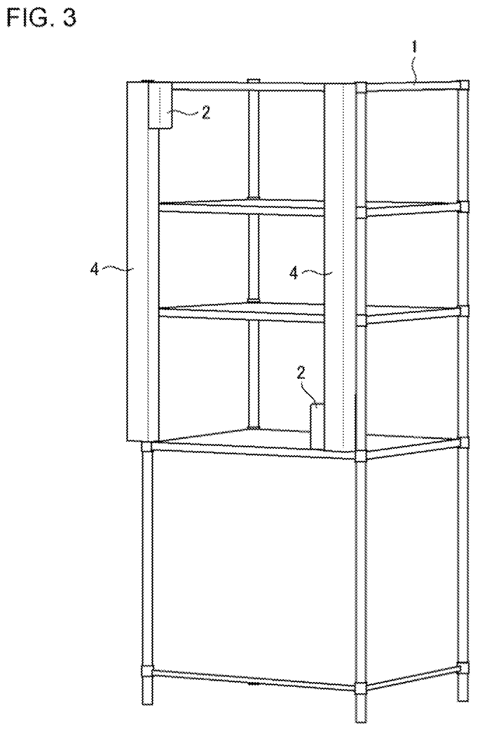

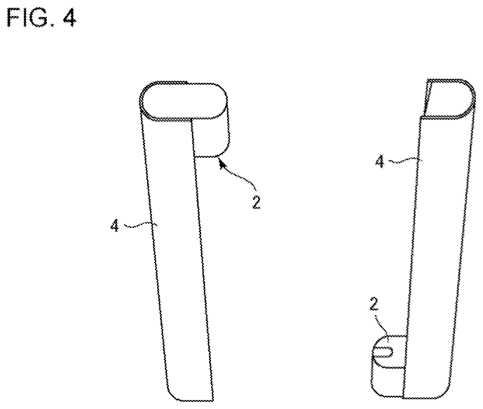

Herein, one example of camera placement is illustrated. Note that, the camera placement example described herein is merely one example, and the present invention is not limited thereto. In an example illustrated in FIG. 3, two cameras 2 are placed for each product display shelf 1. FIG. 4 is a diagram in which a frame 4 in FIG. 3 is extracted. The camera 2 and an illumination (not illustrated) are provided for each of two components constituting the frame 4.

A light radiation surface of the illumination extends in one direction, and includes a light emission unit, and a cover covering the light emission unit. The illumination mainly radiates light in a direction being orthogonal to an extension direction of the light radiation surface. The light emission unit includes a light emission element such as an LED, and radiates light in a direction that is not covered by the cover. Note that, when the light emission element is an LED, a plurality of LEDs are arranged in a direction (an up-down direction in the figure) in which the illumination extends.

Then, the camera 2 is provided on one end side of the component of the linearly extending frame 4, and includes a capture range in a direction in which light of an illumination is radiated. For example, in the component of the left frame 4 in FIG. 4, the camera 2 includes a downward and diagonally lower right capture range. Moreover, in the component of the right frame 4 in FIG. 4, the camera 2 includes an upward and diagonally upper left capture range.

As illustrated in FIG. 3, the frame 4 is attached to a front surface frame (or front surfaces of side walls on both sides) of the product display shelf 1 constituting a product mounting space. One of the components of the frame 4 is attached to one front surface frame in a direction in which the camera 2 is positioned below, and another of the components of the frame 4 is attached to another front surface frame in a direction in which the camera 2 is positioned above. Then, the camera 2 attached to one of the components of the frame 4 captures upward and diagonally upward in such a way as to include an opening of the product display shelf 1 in a capture range. On the other hand, the camera 2 attached to the another of the components of the frame 4 captures downward and diagonally downward in such a way as to include the opening of the product display shelf 1 in a capture range. By configuring in this way, the whole range of the opening of the product display shelf 1 can be captured with the two cameras 2. As a result, it becomes possible to capture, with the two cameras 2, a product taken out from the product display shelf 1 (product picked up by a customer).

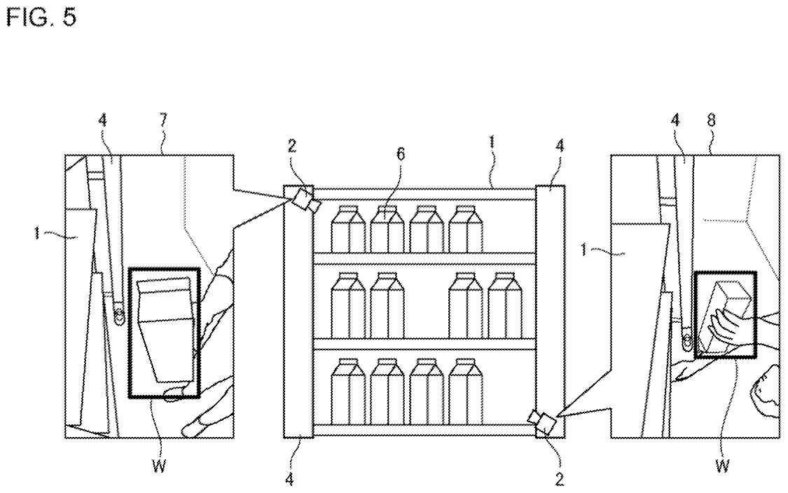

When the configuration illustrated in FIGS. 3 and 4 is adopted, it becomes possible to capture, with the two cameras 2, a scene in which a customer takes out a product from a product shelf 1, as illustrated in FIG. 5. Images 7 and 8 generated by such a camera 2 include the product taken out from the product shelf 1 by the customer.

Moreover, in utilization scenes of Non-Patent Document 3 and Patent Document 2, a product of an accounting target needs to be recognized. In this case, a camera is placed on an accounting apparatus, and the camera captures the product. As disclosed in, for example, Non-Patent Document 3, a camera may be configured in such a way as to collectively capture one or a plurality of products mounted on a table. Otherwise, as disclosed in Patent Document 2, a camera may be configured in such a way as to capture products one by one in response to an operation of an operator (an operation of positioning a product in front of the camera).

Returning to FIG. 2, the detection unit 12 detects, from a candidate image, a target region being a region including an observation target. The observation target is a product, a predetermined object other than a product, or a predetermined marker. A predetermined object other than a product, and a predetermined marker are an object and a marker existing in a region captured by a camera and being always (unless the product or the marker becomes a blind spot) included in an image generated by a camera. For example, in an example of FIG. 5, the product display shelf 1 or the frame 4 included in the images 7 and 8 may be an observation target. Moreover, although not illustrated, a predetermined marker may be affixed at a predetermined position of the product display shelf 1 or the frame 4. Then, the marker may be determined as an observation target.

An observation target can be detected by utilizing any conventional technique. When an observation target is a product, for example, an estimation model for evaluating likelihood of an image of an object generated by machine learning, deep learning, or the like may be utilized, a technique of taking a difference between a previously prepared background image (an image in which a person or a product picked up by a person is not included, and only a background exists) and a candidate image may be utilized, a technique of detecting a person and removing a person from a candidate image may be utilized, or another technique may be utilized.

Moreover, when an observation target is a predetermined object other than a product, or is a predetermined marker, a feature value of appearance of the observation target may be previously registered. Then, the detection unit 12 may detect, from among candidate images, a region matching the feature value. Moreover, when a position of an observation target is fixed, and a position and a direction of a camera are fixed, a region where the observation target exists within the candidate image is fixed. In this case, the region where the observation target exists within the candidate image may be previously registered. Then, the detection unit 12 may detect, as a target region, the previously registered region within the candidate image.

Note that, the detection unit 12 may detect, as a target region, a region (e.g., a rectangular region indicated by a frame W in FIG. 5) including an observation target and a periphery thereof. Otherwise, the detection unit 12 may detect, as a target region, a region with a shape along an outline of an object or the like in which only an observation target exists. The latter can be achieved by utilizing, for example, a method, called as a semantic segmentation or an instance segmentation, of detecting a pixel region in which a detection target exists. Moreover, when a region where an observation target exists within a candidate image is fixed, the region where only the observation target exists can be detected as a target region by previously registering the region where only the observation target exists.

Returning to FIG. 2, the computation unit 13 computes an evaluation value of an image of a target region. When an observation target is a product, an evaluation value is a value relating to luminance of a target region, a value relating to a size of a target region, or the number of keypoints extracted from a target region.

A value relating to luminance of a target region indicates a state of the luminance of the target region. For example, a value relating to luminance of a target region may be a “statistical value (an average value, median, a mode, a maximum value, a minimum value, or the like) of luminance of a pixel included in the target region”, may be a “ratio of the number of pixels with luminance being within a criterion range to the number of pixels included in the target region”, or may be another value.

A value relating to a size of a target region indicates a size of the target region. For example, a value relating to a size of a target region may indicate an area of the target region, may indicate a size of an outer periphery of the target region, or may indicate another value. The area of the target region or the size of the outer periphery is indicated by, for example, the number of pixels.

The number of keypoints extracted from a target region is the number of keypoints extracted when extraction of a keypoint is performed with a predetermined algorithm. What point and with what algorithm to extract as a keypoint is a matter of design, but, for example, a corner point, a point where lines cross, or the like present in a pattern or the like of a package of a product is extracted as a keypoint.

On the other hand, when an observation target is a predetermined object other than a product or a predetermined marker, an evaluation value is a value relating to luminance of a target region or the number of keypoints extracted from a target region. A value relating to a size of a target region is not adopted as an evaluation value in this case because a position of the observation target is fixed, and, when a position and a direction of a camera are fixed, a size of a target region including the observation target becomes almost the same in every candidate image.

When an evaluation value satisfies a criterion, the registration unit 14 registers a candidate image thereof as an image for learning in machine learning or deep learning. The candidate image registered as an image for learning is stored in the storage unit 15. Note that, the storage unit 15 may be provided inside the processing apparatus 10, or may be provided in an external apparatus configured to be communicable with the processing apparatus 10.

When an evaluation value is a value relating to luminance of a target region, a criterion is that “a value relating to luminance is within a predetermined numerical range”. An image with too low luminance and an image with too high luminance have a high possibility that a feature part of a product is not clearly captured, and are not suitable in product recognition. According to the criterion, a candidate image in which luminance of an image of a target region is within a preferable range in product recognition, and in which a possibility that a feature part of a product is clearly captured is high can be registered as an image for learning.

When an evaluation value is a value relating to a size of a target region, a criterion is that “a value relating to a size is equal to or more than a criterion value”. When a target region is small, and a product within an image is small, a possibility that a feature part of a product is not clearly captured is high, and this is not suitable in product recognition. According to the criterion, a candidate image in which a size of an image of a target region is sufficiently large, and in which a possibility that a feature part of a product is clearly captured is high can be registered as an image for learning.

When an evaluation value is the number of keypoints extracted from a target region, a criterion is that “the number of extracted keypoints is equal to or more than a criterion value”. An image in which luminance of a target region is too high, an image in which luminance of a target region is too low, an image in which a target region is small, and an image that is unclear for other reasons such as out-of-focus have a high possibility that a feature part of a product is not clearly captured, and are not suitable in product recognition. Each of such images becomes low in the number of keypoints to be extracted from a target region. According to the criterion, a candidate image clearly capturing a feature part of a product to a degree that the number of keypoints is sufficiently extracted can be registered as an image for learning.

Note that, estimation processing of executing learning (machine learning or deep learning) based on a registered image for learning, and generating an estimation model for recognizing a product included in the image may be performed by the processing apparatus 10, or may be performed by another apparatus. Labeling of an image for learning is performed, for example, manually.

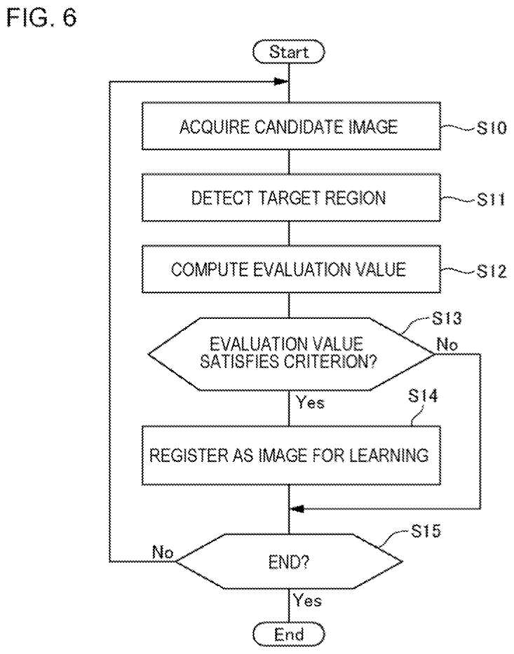

Next, one example of a flow of processing in the processing apparatus 10 is described by use of a flowchart in FIG. 6.

First, when the acquisition unit 11 acquires a candidate image including a product (S10), the detection unit 12 detects, from the candidate image, a target region being a region including an observation target (S11). The observation target is a product, a predetermined object other than a product, or a predetermined marker.

Next, the computation unit 13 computes an evaluation value of an image of the target region detected in S11 (S12). When the observation target is a product, an evaluation value is a value relating to luminance of the target region, a value relating to a size of the target region, or the number of keypoints extracted from the target region. When the observation target is a predetermined object other than a product, or a predetermined marker, an evaluation value is a value relating to luminance of the target region or the number of keypoints extracted from the target region.

Then, when the evaluation value computed in S12 satisfies a previously determined criterion (Yes in S13), the registration unit 14 registers a candidate image thereof as an image for learning in machine learning or deep learning (S14). Similar processing is repeated afterwards.

On the other hand, when the evaluation value computed in S12 does not satisfy a previously determined criterion (No in S13), the registration unit 14 does not register a candidate image thereof as an image for learning in machine learning or deep learning. Then, similar processing is repeated afterwards.

### “Advantageous Effect”

The processing apparatus 10 can select a candidate image being preferable as an image for learning (a candidate image satisfying a predetermined criterion), from among candidate images (images including a product desired to be recognized) prepared for learning in machine learning or deep learning, and register the selected candidate image as an image for learning. Such a processing apparatus 10 does not utilize all of prepared candidate images for learning, but can utilize, for learning, only a carefully selected candidate image being preferable as an image for learning. As a result, accuracy of product recognition of an estimation model acquired by learning improves.

Moreover, the processing apparatus 10 can determine whether a candidate image is preferable as an image for learning, based on luminance of the candidate image, a size of a product within the candidate image, the number of keypoints extracted from the target region, or the like. The processing apparatus 10 that determines with such a characteristic method can accurately select, from among a large number of candidate images, a candidate image clearly capturing a feature part of a product and being preferable as an image for learning, and register the selected candidate image as an image for learning.

Moreover, the processing apparatus 10 can determine whether a candidate image is preferable as an image for learning, based on a partial region (target region) including an observation target within the candidate image. A product being a target desired to be recognized may be captured in a state being preferable for product recognition, and capturing of another product and the like is not put in question. However, when the determination is performed based on a whole of a candidate image, there is a possibility that the candidate image is determined not to be preferable as an image for learning in such a case that an image of a target region is preferable as an image for learning, or an image of another region is not preferable. By determining whether a candidate image is preferable as an image for learning, based on a partial region (target region) including an observation target within the candidate image, such inconvenience can be lessened, and a candidate image being preferable as an image for learning can be accurately selected.

### Second Example Embodiment

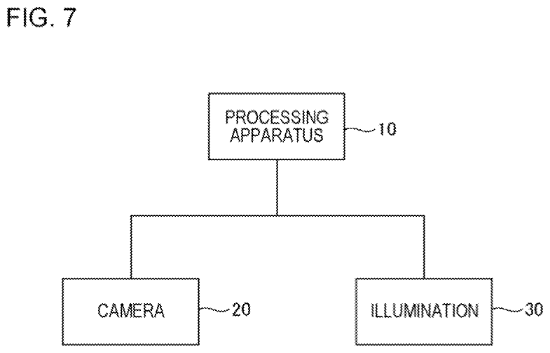

As illustrated in FIG. 7, a processing apparatus 10 according to the present example embodiment wiredly and/or wirelessly connects and is communicable with a camera 20 that generates a candidate image, and illumination 30 that illuminates a capture region of the camera 20. For example, the camera 20 is a camera 2 illustrated in FIGS. 3 to 5, and the illumination 30 is an illumination provided in a frame 4 illustrated in FIGS. 3 to 5.

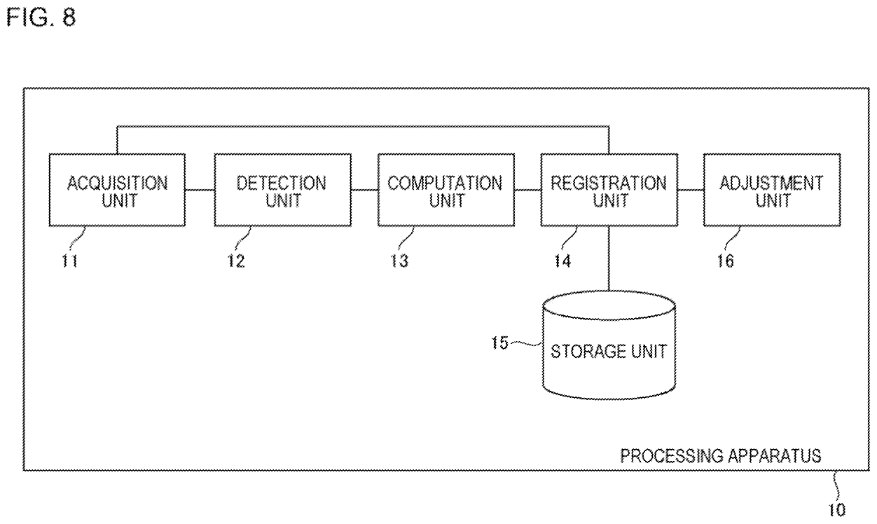

One example of a functional block diagram of the processing apparatus 10 is illustrated in FIG. 8. The processing apparatus 10 according to the present example embodiment includes an adjustment unit 16, and, in this point, differs from the first example embodiment.

When an evaluation value computed by a computation unit 13 does not satisfy a criterion, the adjustment unit 16 changes a capture condition. The evaluation value and the criterion are as described in the first example embodiment. For example, when an evaluation value does not satisfy a criterion, the adjustment unit 16 transmits a control signal to at least one of the camera 20 and the illumination 30, and changes at least one of a parameter of the camera and brightness of the illumination 30. A parameter of the camera 20 to be changed can affect an evaluation value, and is, for example, a parameter (an aperture, a shutter velocity, ISO sensitivity, or the like) or the like that can affect exposure. A change of brightness of the illumination 30 is achieved by a well-known dimming function (PWM dimming, phase control dimming, digital control dimming, or the like). An adjustment example of a capture condition by the adjustment unit 16 is indicated below.

### Adjustment Example 1

For example, when a value relating to luminance of a target region is higher than a predetermined numerical range (the luminance of the target region is too high), the adjustment unit 16 executes an adjustment of at least one of “dimming the illumination 30” and “changing a parameter of the camera 20 in a direction in which luminance (brightness) of an image is lowered”.

Moreover, when a value relating to luminance of a target region is lower than a predetermined numerical range (the luminance of the target region is too low), the adjustment unit 16 executes an adjustment of at least one of “brightening the illumination 30” and “changing a parameter of the camera 20 in a direction in which luminance (brightness) of an image is heightened”.

### Adjustment Example 2

Otherwise, for example, when a capture region of the camera 20 is illuminated with a plurality of the illuminations 30 as in the examples illustrated in FIGS. 3 to 5, the adjustment unit 16 can individually control a plurality of the illuminations 30.

Then, when a value relating to luminance of a target region is lower than a predetermined numerical range (the luminance of the target region is too low), the adjustment unit 16 performs an adjustment of at least one of “dimming the illumination 30 positioned on an opposite side to the camera 20 across a product” and “brightening the illumination 30 positioned on a nearer side than a product when seen from the camera 20”.

Moreover, when a value relating to luminance of a target region is higher than a predetermined numerical range (the luminance of the target region is too high), the adjustment unit 16 performs an adjustment of “dimming the illumination 30 positioned on a nearer side than a product when seen from the camera 20”.

### Adjustment Example 3

Otherwise, for example, when a product is captured with a plurality of the cameras 20 from directions differing from each other as in the examples illustrated in FIGS. 3 to 5, and an acquisition unit 11 acquires a plurality of images generated by a plurality of the cameras 20, the adjustment unit 16 can select one of the cameras 20, based on a size of a product within an image in each of images generated by a plurality of the cameras 20, and adjust, based on a selection result, brightness of the illumination 30 illuminating the product. For example, the adjustment unit 16 selects the camera 20 generating an image in which a size of a product within an image is the largest. This selection means selecting the camera 20 being best suited to capture the product from among a plurality of the cameras 20. The camera 20 that can capture a product largest is selected as the camera 20 being best suited to capture the product.

Then, when a value relating to luminance of a target region is lower than a predetermined numerical range (the luminance of the target region is too low) in an image generated by the selected camera 20, the adjustment unit 16 performs an adjustment of at least one of “dimming the illumination 30 positioned on an opposite side to the selected camera 20 across a product” and “brightening the illumination 30 positioned on a nearer side than the product when seen from the selected camera 20”.

Moreover, when a value relating to luminance of a target region is higher than a predetermined numerical range (the luminance of the target region is too high) in an image generated by the selected camera 20, the adjustment unit 16 performs an adjustment of “dimming the illumination 30 positioned on a nearer side than a product when seen from the camera 20”.

### Adjustment Example 4

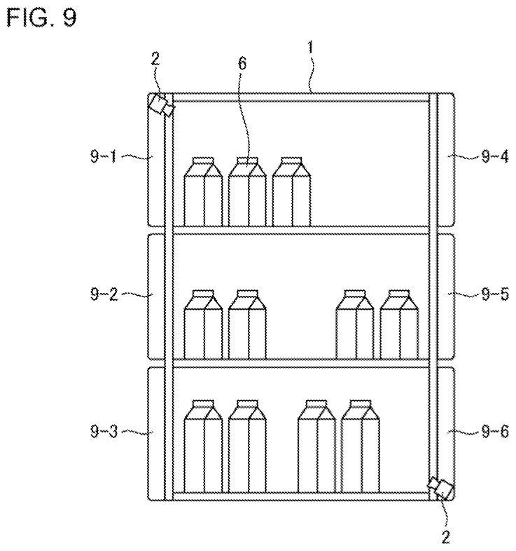

Otherwise, for example, a plurality of the illuminations 30 being capable of individually adjusting brightness, for example, for each stage of a product display shelf 1 may be placed. One example is illustrated in FIG. 9. In the example illustrated in the figure, six illuminations 9-1 to 9-6 being capable of individually adjusting brightness are placed in the three-stage product display shelf 1.

The adjustment unit 16 determines a stage where a product included in a candidate image has been displayed. Means for determining a stage where a product included in a candidate image has been displayed are varied. For example, when a plurality of time-series candidate images are generated in such a way as to include the product display shelf 1 as illustrated in FIG. 5, what stage a product has been taken out from can be determined by tracking a position of the product, based on a plurality of the time-series candidate images.

Then, the adjustment unit 16 adjusts brightness of an illumination being associated with the determined stage. A way of adjustment is similar to that in each of the adjustment examples 1 to 3 described above. According to the adjustment example, adjusting only the illumination being positioned close to a product and having a great effect on the product can achieve a sufficient effect of adjustment, while avoiding unnecessary adjustment of the illumination 30.

Note that, the adjustment unit 16 determines a position relation between each of the cameras 20 and each of the illuminations 30, based on previously generated “information indicating the illumination 30 positioned on an opposite side to each of the cameras 20 across a product existing in a capture region” and “information indicating the illumination 30 positioned on a nearer side than a product existing in a capture region when seen from each of the cameras 20”, and performs the control described above.

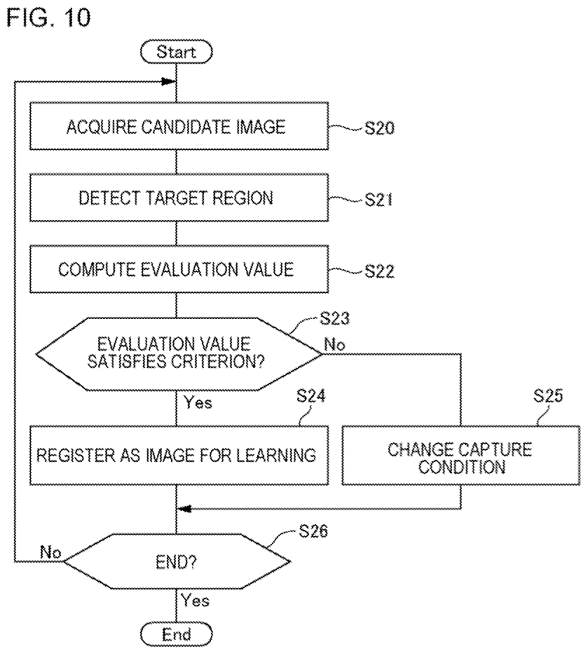

Next, one example of a flow of processing in the processing apparatus 10 is described by use of a flowchart in FIG. 10.

First, when the acquisition unit 11 acquires a candidate image including a product (S20), a detection unit 12 detects, from the candidate image, a target region being a region including an observation target (S21). The observation target is a product, a predetermined object other than a product, or a predetermined marker. The acquisition unit 11 acquires, by real-time processing, the candidate image generated by the cameras 20, for example.

Next, the computation unit 13 computes an evaluation value of an image of the target region detected in S21 (S22). When the observation target is a product, an evaluation value is a value relating to luminance of the target region, a value relating to a size of the target region, or the number of keypoints extracted from the target region. When the observation target is a predetermined object other than a product, or a predetermined marker, an evaluation value is a value relating to luminance of the target region or the number of keypoints extracted from the target region.

Then, when the evaluation value computed in S22 satisfies a previously determined criterion (Yes in S23), a registration unit 14 registers a candidate image thereof as an image for learning in machine learning or deep learning (S24). Similar processing is repeated afterwards.

On the other hand, when the evaluation value computed in S22 does not satisfy a previously determined criterion (No in S23), the registration unit 14 does not register a candidate image thereof as an image for learning in machine learning or deep learning. In this case, the adjustment unit 16 changes at least one of brightness of an illumination illuminating a product, and a parameter of a camera that generates an image, for example, as illustrated in the adjustment examples 1 to 4 described above (S25). As a result, the brightness of the illumination or the parameter of the camera is changed in real time and dynamically. Then, similar processing is repeated afterwards.

Other components of the processing apparatus 10 according to the present example embodiment are similar to those according to the first example embodiment.

The processing apparatus 10 according to the present example embodiment described above achieves an advantageous effect similar to that according to the first example embodiment. Moreover, the processing apparatus 10 according to the present example embodiment can change, in real time and dynamically, brightness of an illumination illuminating a product, or a parameter of a camera that generates an image, based on the generated image. Thus, it becomes possible to efficiently generate a candidate image in which an evaluation value satisfies a criterion, without a troublesome adjustment operation by an operator.

While the invention of the present application has been described above with reference to the example embodiments (and examples), the invention of the present application is not limited to the example embodiments (and examples) described above. Various changes that a person skilled in the art is able to understand can be made to a configuration and details of the invention of the present application, within the scope of the invention of the present application.

Some or all of the above-described example embodiments can also be described as, but are not limited to, the following supplementary notes.

1. A processing apparatus including:

an acquisition unit that acquires an image including a product;

a detection unit that detects, from the image, a target region being a region including an observation target;

a computation unit that computes an evaluation value of an image of the target region; and

a registration unit that registers the image as an image for learning, when the evaluation value satisfies a criterion.

2. The processing apparatus according to supplementary note 1, wherein

the observation target is the product, a predetermined object other than the product, or a predetermined marker.

3. The processing apparatus according to supplementary note 1 or 2, wherein,

when the observation target is the product, the evaluation value is a value relating to luminance of the target region, a value relating to a size of the target region, or a number of keypoints extracted from the target region, and,

when the observation target is a predetermined object other than the product, or the predetermined marker, the evaluation value is a value relating to luminance of the target region or a number of keypoints extracted from the target region.

4. The processing apparatus according to any one of supplementary notes 1 to 3, further including

an adjustment unit that changes a capture condition, when the evaluation value does not satisfy a criterion.

5. The processing apparatus according to supplementary note 4, wherein,

when the evaluation value does not satisfy a criterion, the adjustment unit changes at least one of brightness of an illumination illuminating the product, and a parameter of a camera that generates the image.

6. The processing apparatus according to supplementary note 5, wherein

the acquisition unit acquires the images generated by a plurality of cameras that capture the product from directions differing from each other, and

the adjustment unit
selects one of the cameras, based on a size of the product within the image in each of the images generated by each of the plurality of cameras, and
adjusts, based on a selection result, brightness of an illumination illuminating the product.
   7. The processing apparatus according to supplementary note 6, wherein

the adjustment unit performs at least one of
dimming an illumination positioned on an opposite side to the selected camera across the product, and
brightening an illumination positioned on a nearer side than the product when seen from the selected camera.
   8. The processing apparatus according to any one of supplementary notes 5 to 7, wherein

the acquisition unit acquires the image including the product taken out from a product display shelf having a plurality of stages,

an illumination is provided for each stage of the product display shelf, and

the adjustment unit
determines a stage where the product included in the image is displayed, and
adjusts brightness of an illumination being associated with a determined stage.
   9. A processing method including,

by a computer:
acquiring an image including a product;
detecting, from the image, a target region being a region including an observation target;
computing an evaluation value of an image of the target region; and
registering the image as an image for learning, when the evaluation value satisfies a criterion.
   10. A program causing a computer to function as:

an acquisition unit that acquires an image including a product;

a detection unit that detects, from the image, a target region being a region including an observation target;

a computation unit that computes an evaluation value of an image of the target region; and

a registration unit that registers the image as an image for learning, when the evaluation value satisfies a criterion.

What is claimed is:

1. A processing apparatus comprising:
at least one memory configured to store one or more instructions; and
at least one processor configured to execute the one or more instructions to:
acquire an image including a product;
detect, from the image, a target region being a region including an observation target;
compute an evaluation value of an image of the target region; and
register the image as an image for learning, when the evaluation value satisfies a criterion.

2. The processing apparatus according to claim 1, wherein
the observation target is the product, a predetermined object other than the product, or a predetermined marker.

3. The processing apparatus according to claim 1, wherein,
when the observation target is the product, the evaluation value is a value relating to luminance of the target region, a value relating to a size of the target region, or a number of keypoints extracted from the target region, and,
when the observation target is a predetermined object other than the product, or the predetermined marker, the evaluation value is a value relating to luminance of the target region or a number of keypoints extracted from the target region.

4. The processing apparatus according to claim 1,
wherein the processor is further configured to execute the one or more instructions to change a capture condition, when the evaluation value does not satisfy a criterion.

5. The processing apparatus according to claim 4,
wherein the processor is further configured to execute the one or more instructions to change, when the evaluation value does not satisfy a criterion, the at least one of brightness of an illumination illuminating the product, and a parameter of a camera that generates the image.

6. The processing apparatus according to claim 5, wherein the processor is further configured to execute the one or more instructions to:
acquire the images generated by a plurality of cameras that capture the product from directions differing from each other,
select one of the cameras, based on a size of the product within the image in each of the images generated by each of the plurality of cameras, and
adjust, based on a selection result, brightness of an illumination illuminating the product.

7. The processing apparatus according to claim 6, wherein the processor is further configured to execute the one or more instructions to perform at least one of
dimming an illumination positioned on an opposite side to the selected camera across the product, and
brightening an illumination positioned on a nearer side than the product when seen from the selected camera.

8. The processing apparatus according to claim 5, wherein
the processor is further configured to execute the one or more instructions to acquire the image including the product taken out from a product display shelf having a plurality of stages,
an illumination is provided for each stage of the product display shelf, and
the processor is further configured to execute the one or more instructions to:
determine a stage where the product included in the image is displayed, and
adjust brightness of an illumination being associated with a determined stage.

9. A processing method comprising,
by a computer:
acquiring an image including a product;
detecting, from the image, a target region being a region including an observation target;
computing an evaluation value of an image of the target region; and
registering the image as an image for learning, when the evaluation value satisfies a criterion.

10. A non-transitory storage medium storing a program causing a computer to:
acquire an image including a product;
detect, from the image, a target region being a region including an observation target;
compute an evaluation value of an image of the target region; and
register the image as an image for learning, when the evaluation value satisfies a criterion.
